(19) United States
(12) Patent Application Publication
(10) Pub. No.: US 2018/0051592 A1
(43) Pub. Date: Feb. 22, 2018

(54) ROTOR PIVOTING SYSTEM

(71) Applicant: SIEMENS AKTIENGESELLSCHAFT, Muenchen (DE)

(72) Inventors: Matthias RICHTER, Berlin (DE); Marcus ROCHLITZER, Mühlhausen (DE)

(21) Appl. No.: 15/797,516

(22) Filed: Oct. 30, 2017

Related U.S. Application Data
(63) Continuation-in-part of application No. 14/598,694, filed on Jan. 16, 2015, now abandoned.

(30) Foreign Application Priority Data
Jan. 17, 2014 (DE) 102014200760.7

(51) Int. Cl. F01D 25/28; F01D 5/00; B23P 6/00

(52) U.S. Cl. CPC F01D 25/285; F01D 5/005; F05D 2230/80; F05D 2220/32; F05D 2230/72; B23P 6/002

(57) ABSTRACT

A rotor pivoting system (1) for setting a rotor (2) upright, for the purpose of maintenance and/or repair work: a turning pedestal (9) having a pivoting device (10), and at least one bearing pedestal (11) for supporting the rotor when not upright; a heavy-duty stand (3) with a multiplicity of vertically extendable supporting feet (4, 5) which receive the turning pedestal and the bearing pedestal and is transportable and introduces forces occurring when a rotor arranged on the turning pedestal (9) and the bearing pedestal (11) is being set upright, via the supporting feet (4, 5), into a base on which said stand is positioned. Also, a method for carrying out maintenance and/or repair work on a rotor (2) of a machine using a rotor pivoting system (1) according to the invention.

### CROSS-REFERENCE TO RELATED APPLICATIONS

This application is a continuation-in-part of U.S. patent application Ser. No. 14/598,694, filed Jan. 16, 2015, which claims priority of German Patent Application No. 102014200760.7, filed Jan. 17, 2014, the contents of which are incorporated by reference herein.

### BACKGROUND OF THE INVENTION

The present invention relates to a rotor pivoting system for setting upright a rotor, in particular a gas turbine rotor, for the purpose of carrying out maintenance and/or repair work, the rotor pivoting system comprising a turning pedestal, having a pivoting device, and at least one bearing pedestal.

Maintenance and/or repair work on a rotor are advantageously carried out while it is in a vertical position. In particular, the destacking of a gas turbine rotor is considerably simplified in this way. To set rotors having a high dead weight upright, rotor pivoting systems are employed in the prior art. These comprise a turning pedestal, with a pivoting device arranged on it, and at least one bearing pedestal. In a first step, the turning pedestal and the bearing pedestal are set up on the floor of an industrial hangar and oriented with one another. At least the turning pedestal is anchored to the hangar floor by suitable fastening means. In a further step, the rotor to be processed is deposited, using a crane, on the turning pedestal and the bearing pedestal and is thereupon fastened to the pivoting device provided on the turning pedestal. Then, using the pivoting device and employing a crane, the rotor can be transferred into the vertical position and locked there, in order to carry out the pending maintenance and/or repair work on the upright rotor.

One disadvantage of known rotor pivoting systems is that their use presupposes an industrial periphery at least in the form of an industrially manufactured base, on which the turning pedestal and the at least one bearing pedestal are arranged and into which the forces occurring when the rotor is being set upright can be introduced by the turning pedestal. However, since such a periphery is not always present, the ability to use the known rotor pivoting systems is restricted.

### SUMMARY OF THE INVENTION

Proceeding from this prior art, an object of the present invention is to provide a rotor pivoting system of the type initially mentioned, which can be used in a flexible way.

To achieve this object, the present invention provides a rotor pivoting system of the type initially mentioned, which has a heavy-duty stand provided with a multiplicity of vertically extendable supporting feet. It accommodates the turning pedestal and the bearing pedestal. It is of the transportable type. It is designed for introducing the forces occurring when a rotor arranged on the turning pedestal and the bearing pedestal is being set upright, via the supporting feet, into a base on which said stand is positioned.

An essential advantage of the rotor pivoting system according to the invention is that, by virtue of the vertically extendable supporting feet of the heavy-duty stand the pivoting system can be positioned even on bases which are uneven. Therefore, use of the rotor pivoting system according to the invention is not limited to locations where an even base manufactured industrially for the absorption of heavy loads is present. The rotor pivoting system according to the invention can correspondingly be used in a very flexible way. the forces occurring when the rotor is being set upright are introduced into the base not only via the turning pedestal, but also via the multiplicity of supporting feet arranged on the heavy-duty stand, very good load distribution is achieved, and therefore the base has to fulfill comparatively low requirements for the rotor pivoting system according to the invention to be used. The heavy-duty stand of the rotor pivoting system according to the invention is, furthermore, of the transportable type, so that it can be transported to the site of the rotor to be processed. It correspondingly becomes possible to carry out maintenance and/or repair work in situ.

According to a preferred refinement of the present invention, the heavy-duty stand is designed for reception of rotors having a dead weight of up to 60 t, in particular of rotors having a dead weight of up to 100 t. The ability to use the rotor pivoting system according to the invention is correspondingly flexible.

Preferably, floorboards are arranged on the heavy-duty stand. The floorboards of that type can be walked on without difficulty by the operating personnel, enabling very good handling ability of the rotor pivoting system.

Advantageously, at least some of the supporting feet are extendable horizontally, which improves the stability and steadiness of the heavy-duty stand.

Advantageously, the supporting feet are hydraulically actuable or extendable, improving the handling of the rotor pivoting system according to the invention.

According to a variant of the present invention, the heavy-duty stand has walls, in particular end walls. The dimensions of the walls are selected such that they correspond essentially to the dimensions of walls of a standard container, in particular of an ISO 49′ container. The rotor pivoting system according to the invention can therefore be transported without difficulty.

The heavy-duty stand advantageously has a roof fastenable to the walls or a fastenable tarpaulin, having dimensions which correspond essentially to those of the roof or of the tarpaulin of a standard container, in particular of an ISO 49′ container.

The walls extending in the longitudinal direction are preferably designed to be partly foldable or dismountable, in such a way that they can be folded down or removed, when the rotor pivoting system is being set up, so that the turning pedestal and the bearing pedestal are freely accessible.

In an alternative variant, the heavy-duty stand has dimensions which are selected such that the heavy-duty stand can be accommodated in a standard container, in particular in an ISO 49′ container.

To achieve the object initially mentioned, the present invention further provides a method for carrying out maintenance and/or repair work on a rotor of a machine, in particular on a gas turbine rotor, using a rotor pivoting system as claimed in one of the preceding claims, which method includes the steps:

setting up the rotor pivoting system at a predetermined location, particularly near the machine site;

orientation of the heavy-duty stand by means of appropriate adjustment of the supporting feet;

arranging a rotor to be processed on the turning pedestal and on the bearing pedestal, using a crane,

fastening the rotor to the pivoting device provided on the turning pedestal;

pivoting the rotor into a vertical position, using the pivoting device and employing a crane;

locking the rotor in the vertical position, and

carrying out the maintenance and/or repair work on the rotor arranged in the vertical position.

According to a variant of the method according to the invention, no base manufactured industrially for the absorption of heavy loads is present at the predetermined set-up location.

Further features and advantages of the present invention become clear from the following description of an embodiment of a rotor pivoting system according to the invention, with reference to the accompanying drawings.

### BRIEF DESCRIPTION OF THE DRAWINGS

FIG. 1 shows a diagrammatic perspective view of a rotor pivoting system according to an embodiment of the present invention;

FIG. 2 shows a bottom view of the rotor pivoting system illustrated in FIG. 1;

FIG. 3 shows a side view of the rotor pivoting system illustrated in FIG. 1;

FIG. 4 shows a perspective view of the rotor pivoting system which is illustrated in FIG. 1 and of the pivoting pedestal and bearing pedestal on which a rotor to be processed is positioned;

FIG. 5 shows a view of the arrangement illustrated in FIG. 4, the rotor being in a position set partially upright;

FIG. 6 shows a view of the arrangement illustrated in FIG. 4, in which the rotor is in a position set upright completely;

FIG. 7 is based on FIG. 1, but adds side walls and a roof;

FIG. 8 is based on FIG. 1, but adds side walls and a tarpaulin;

FIG. 9 is based on FIG. 1, but adds side walls and a roof separated from the remainder of the roof pivoting system; and

FIG. 10 is based on FIG. 1, but adds side walls and a roof shown as pivotable so that they can fold downward about the remainder of the roof pivoting system.

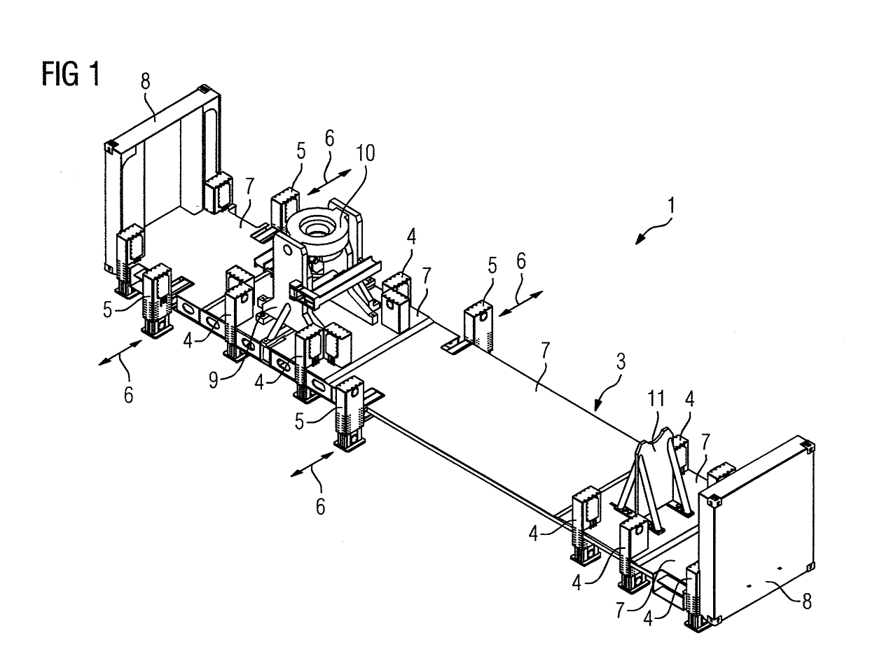

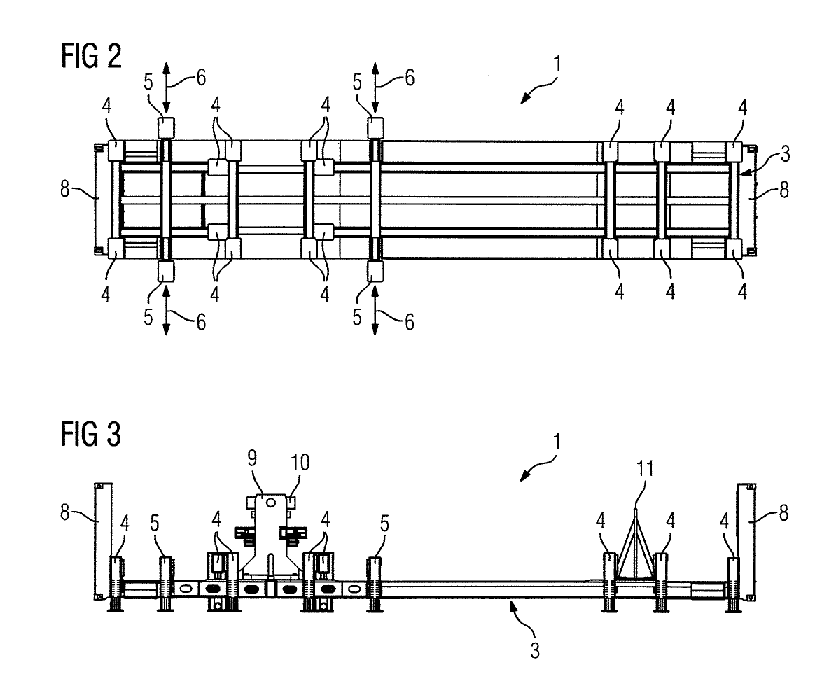

### DESCRIPTION OF AN EMBODIMENT

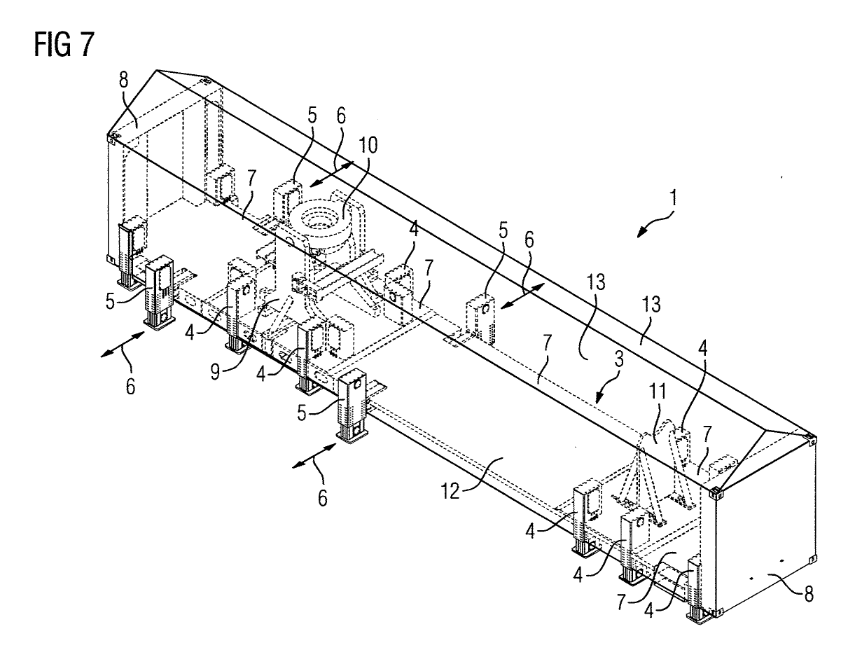

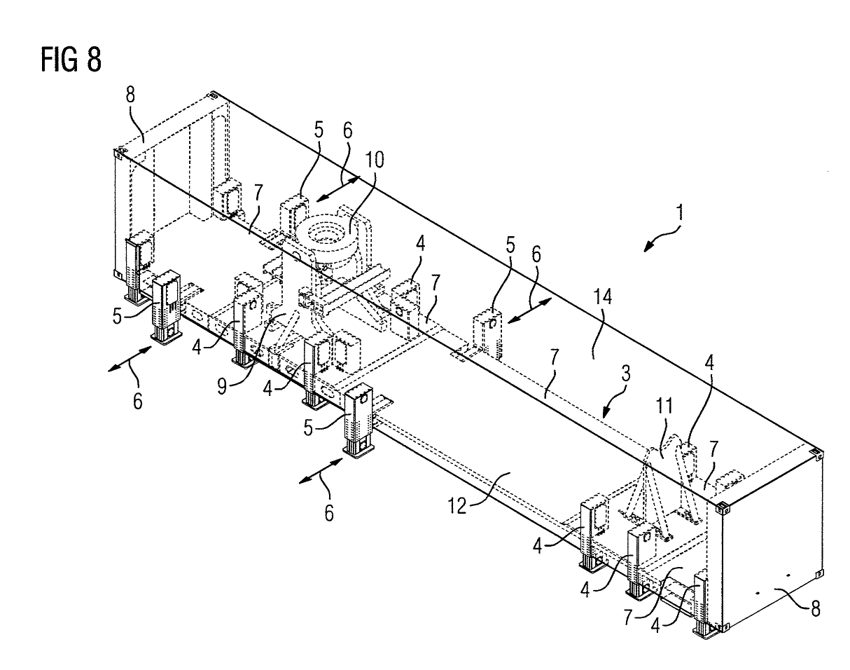

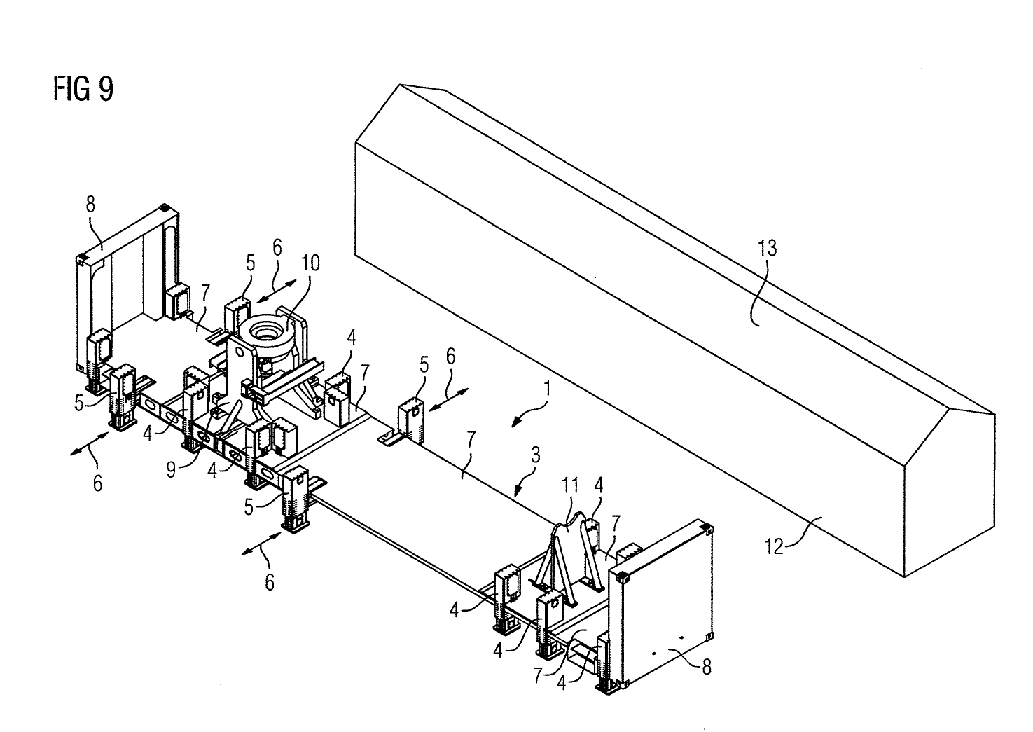

The Figures show a rotor pivoting system 1 according to an embodiment of the present invention, which serves for setting rotors upright, for example for setting a gas turbine rotor 2 upright. The rotor pivoting system 1 comprises a heavy-duty stand 3 which is provided with a multiplicity of vertically extendable supporting feet 4 and 5. Moreover, the supporting feet 5 are extendable horizontally in the direction of the arrows 6, in order, if required, to improve the steadiness of the heavy-duty stand 3. In this case, actuation of the supporting feet 4 and 5 takes place hydraulically, although, of course, alternative actuation variants will also be envisaged. The heavy-duty stand 3, may, for example, be a steel stand. A plurality of floorboards 7, which define a walk-on plane, are held on the stand. The heavy-duty stand has end walls 8 on its end faces. The dimensions of those walls are selected to correspond essentially to those of the end walls of a standard container, in the present case an ISO 49′ container, although, of course, other containers may also be considered. Moreover, the rotor pivoting system 1 comprises side walls 12 extending in the longitudinal direction, (see FIGS. 7 and 8), and also a roof 13, (see FIG. 7), or tarpaulin 14, (see FIG. 8). These components are fastened removably to the heavy-duty stand 3. Although FIG. 7 shows a roof 13, which is peaked, the roof can have a different geometry, such as a flat roof or a roof with a single slope, for example. Furthermore, although FIG. 8 shows tarpaulin 14 as a plane surface, that tarpaulin can have an alternate geometry, such as a peaked tarpaulin or a tarpaulin with a single slope, for example. Overall, therefore, the rotor pivoting system 1 has a container-like arrangement.

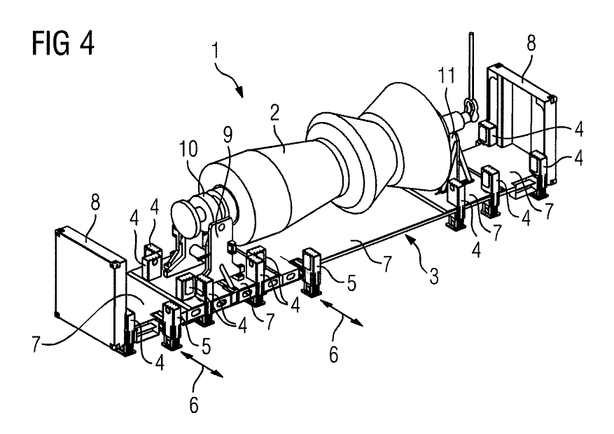

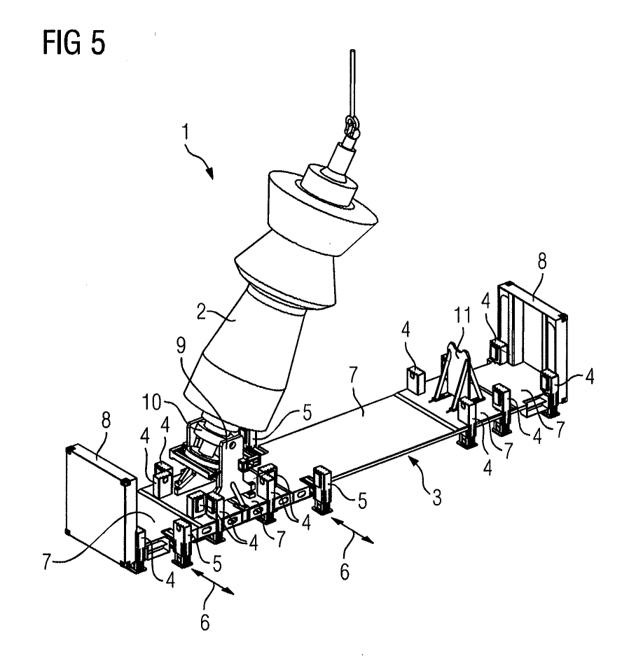

A turning pedestal 9, with a pivoting device 10 arranged on it, and a bearing pedestal 11 are positioned on the heavy-duty stand 3. In the present case, the turning pedestal 9 is anchored to the heavy-duty stand 3, whereas the bearing pedestal 11 is set up loosely on one of the floorboards 7. The turning pedestal 9 and bearing pedestal 11 are oriented with respect to one another so that a rotor 2 can be positioned on them, as is described below in more detail with reference to FIGS. 4 to 6.

The pivoting device 10 is provided with a fastening device, not illustrated in any more detail, which makes it possible to fasten a rotor 2 positioned on the pedestals to the pivoting device 10. Furthermore, the pivoting device 10 comprises a locking device, likewise not designated in any more detail, which enables the pivoting device 10 to be locked at least in a vertical position of a rotor 2 held on it.

Fastening devices and locking devices of the abovementioned type are already known in the prior art, and are therefore not detailed in the present case.

To carry out maintenance and/or repair work on a rotor 2, in a first step the, rotor pivoting system 1 is transported to the processing location. Because the outer dimensions of the rotor pivoting system 1 correspond to the dimensions of a standardized transport container, transport by land, water or air presents no problem.

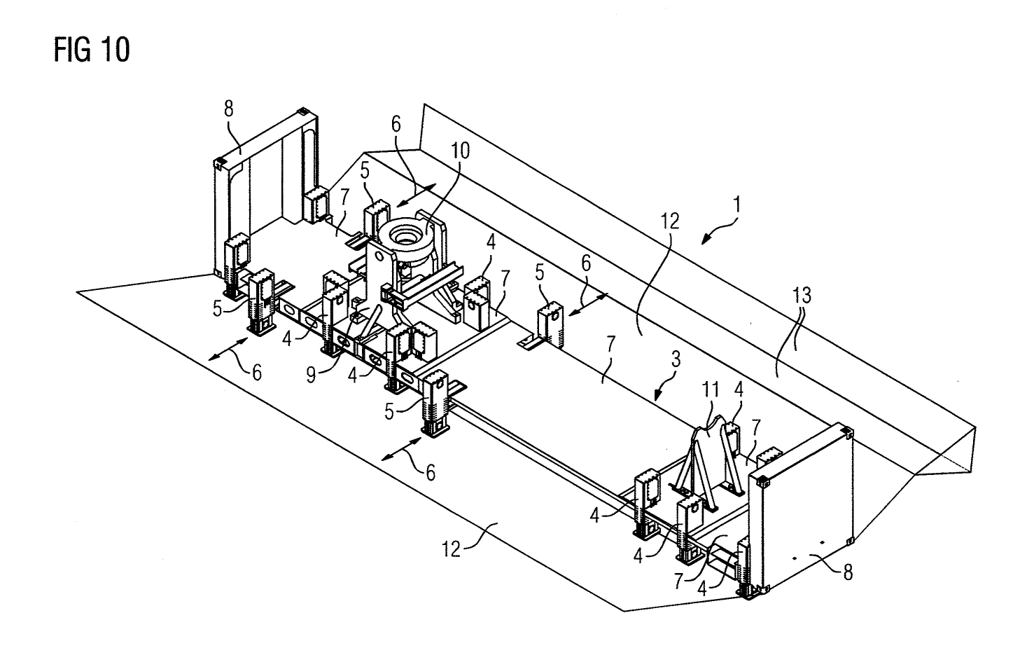

The rotor pivoting system is then set up at the processing location on a suitable base. An essential advantage of the rotor pivoting system 1 according to the invention is that this base does not have to be a base manufactured industrially for the absorption of heavy loads, such as, for example, a hangar floor, but instead the rotor pivoting system can also be set up on natural uneven bases. Owing to the vertical extendability of the supporting feet 4 and 5, the heavy-duty stand 3 can be properly oriented horizontally on almost all bases. Safeguarding against tilting of the heavy-duty stand 3 is achieved by means of the horizontally extendable supporting feet 5. Since the heavy-duty stand 3 is provided with a multiplicity of supporting feet 4 and 5, moreover, very good load distribution is achieved. After the rotor pivoting system 1 has been set up and oriented, in a further step the longitudinally extending side walls 12 and also the roof 13 or the tarpaulin 14 of the rotor pivoting system 1 can be lifted off, using a crane, as shown in FIG. 9 for the side walls 12 and the roof 13. Alternatively, however, as shown in FIG. 10, the side walls 12 and the roof 13 may also be designed to be pivotable, so that they can be folded downward in order to allow access to the turning pedestal 9 and the bearing pedestal 11.

In a further step, the rotor to be processed is then positioned on the turning pedestal 9 and the bearing pedestal 11, using a crane, and thereupon is firmly connected by means of the fastening device, not illustrated in any more detail, to the pivoting device 10 provided on the turning pedestal 9, as is illustrated in FIG. 4.

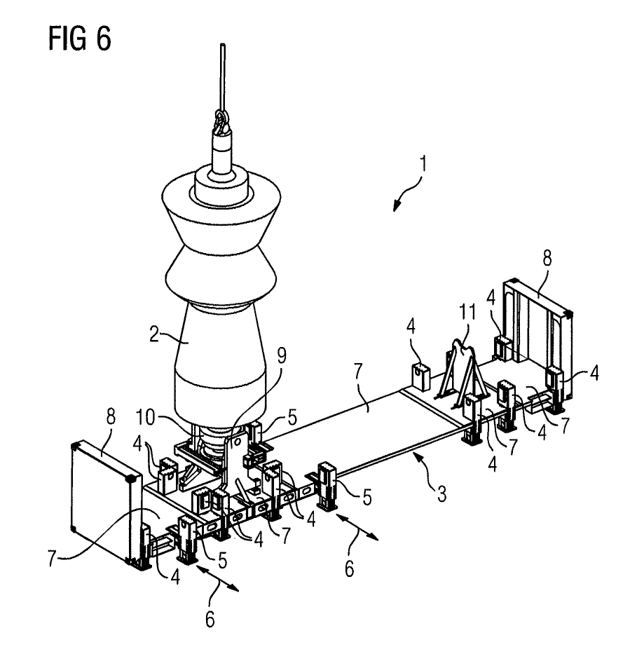

Subsequently, the free end of the rotor 2, lying opposite the turning pedestal 9, has fastened to it a rope of a crane, which aids the rotor 2 being pivoted about the horizontal pivot axis of the pivoting device 10, as is shown in FIG. 5. The pivoting movement is continued until the rotor 2 pivots the vertical position which is illustrated in FIG. 6 and at which it is locked by the locking device, not illustrated in any more detail, of the pivoting device 10 when actuated.

The necessary maintenance and/or repair work can then be carried out on the upright rotor 2, while the rotor 2 continues to be secured by the crane. The maintenance and/or repair work may comprise, for example, a destacking of the rotor 2 or the like.

The dimensions of the rotor pivoting system 1 according to the invention may also be selected so that the rotor pivoting system 1 can be stowed away as a whole in a standard container. This, too, ensures transport without difficulty.

Although the invention has been illustrated and described in detail by means of the preferred exemplary embodiment, the invention is not restricted by the disclosed examples and other variations may be derived from them by a person skilled in the art, without departing from the scope of protection of the invention.

What is claimed is:

1. A rotor pivoting system for setting a rotor in an upright position for maintenance and/or repair work;
the system comprising:
a turning pedestal having a pivoting device designed for pivoting the rotor in the upright position;
at least one bearing pedestal spaced away from the turning pedestal for supporting the rotor when it is not raised or being raised; and
a heavy-duty stand which is provided with a multiplicity of vertically extendable supporting feet arranged at locations around the stand, the feet being located and configured for supporting the pedestals; wherein
the heavy-duty stand receives the turning pedestal and the bearing pedestal;
the heavy-duty stand is transportable;
the heavy-duty stand is designed for introducing forces occurring when a rotor, which is arranged on the turning pedestal and on the bearing pedestal, is being set upright, the introducing of the forces being via the supporting feet, and into a base on which the heavy-duty stand is positioned; and
the pivoting device is configured to hold a first end of the rotor to prevent the first end of the rotor from moving vertically or horizontally relative to the heavy-duty stand, while a second end of the rotor is pivoting relative to the pivoting device and moving vertically and horizontally relative to the heavy-duty stand.

2. The rotor pivoting system as claimed in claim 1, wherein the heavy-duty stand is configured for receiving a rotor having a dead weight of up to 100 t.

3. The rotor pivoting system as claimed in claim 1, wherein floorboards arranged on the heavy-duty stand.

4. The rotor pivoting system as claimed in claim 1, wherein at least some of the supporting feet are extendable horizontally.

5. The rotor pivoting system as claimed in claim 1, wherein the supporting feet are actuable hydraulically.

6. The rotor pivoting system as claimed in claim 1, wherein the heavy-duty stand has walls with dimensions corresponding to dimensions of side walls of an ISO container.

7. A rotor pivoting system for setting a rotor in an upright position for maintenance and/or repair work;
the system comprising:
a turning pedestal having a pivoting device designed for pivoting the rotor in the upright position;
at least one bearing pedestal spaced away from the turning pedestal for supporting the rotor when it is not raised or being raised; and
a heavy-duty stand which is provided with a multiplicity of vertically extendable supporting feet arranged at locations around the stand, the feet being located and configured for supporting the pedestals; wherein
the heavy-duty stand receives the turning pedestal and the bearing pedestal;
the heavy-duty stand is transportable;
the heavy-duty stand is designed for introducing forces occurring when a rotor, which is arranged on the turning pedestal and on the bearing pedestal, is being set upright, the introducing of the forces being via the supporting feet, and into a base on which the heavy-duty stand is positioned;
the pivoting device is configured to hold an end of the rotor to prevent the end of the rotor from moving vertically or horizontally relative to the heavy-duty stand, while a remainder of the rotor other than the end of the rotor is pivoting relative to the pivoting device and moving vertically and horizontally relative to the heavy-duty stand;
the heavy-duty stand has walls with dimensions corresponding to dimensions of side walls of an ISO container; and
the heavy-duty stand has a roof fastenable to the walls of the heavy-duty stand or a tarpaulin fastenable to the walls of the heavy-duty stand, the roof or the tarpaulin having dimensions which correspond to dimensions of a roof or a tarpaulin of an ISO container, respectively.

8. A rotor pivoting system for setting a rotor in an upright position for maintenance and/or repair work;
the system comprising:
a turning pedestal having a pivoting device designed for pivoting the rotor in the upright position;
at least one bearing pedestal spaced away from the turning pedestal for supporting the rotor when it is not raised or being raised; and
a heavy-duty stand which is provided with a multiplicity of vertically extendable supporting feet arranged at locations around the stand, the feet being located and configured for supporting the pedestals; wherein
the heavy-duty stand receives the turning pedestal and the bearing pedestal;
the heavy-duty stand is transportable;
the heavy-duty stand is designed for introducing forces occurring when a rotor, which is arranged on the turning pedestal and on the bearing pedestal, is being set upright, the introducing of the forces being via the supporting feet, and into a base on which the heavy-duty stand is positioned;
the pivoting device is configured to hold an end of the rotor to prevent the end of the rotor from moving vertically or horizontally relative to the heavy-duty stand, while a remainder of the rotor other than the end of the rotor is pivoting relative to the pivoting device and moving vertically and horizontally relative to the heavy-duty stand;
the heavy-duty stand has walls with dimensions corresponding to dimensions of side walls of an ISO container; and
the heavy-duty stand has side walls extending in a longitudinal direction, which are at least partly foldable or removable, so that the turning pedestal and the bearing pedestal are freely accessible.

9. The rotor pivoting system as claimed in claim 1, wherein the heavy-duty stand has dimensions which are selected so that the heavy-duty stand may be accommodated in an ISO container.

10. A method for carrying out maintenance and/or repair work on a rotor of a machine, using a rotor pivoting system as claimed in claim 1, comprising the steps:
setting up the rotor pivoting system at a location;
orienting the heavy-duty stand by adjustment of the supporting feet;
arranging a rotor to be processed on the turning pedestal and on the bearing pedestal, using a crane,
fastening the rotor to the pivoting device of the turning pedestal;
pivoting the rotor into a vertical position, using the pivoting device and employing a crane;
locking of the rotor in the vertical position, and
carrying out the maintenance and/or repair work on the rotor arranged in the vertical position.

11. The method as claimed in claim 10, wherein no base specifically designed for absorption of heavy loads is present at the location.
